(19) United States
(12) Patent Application Publication
(10) Pub. No.: US 2006/0019796 A1
(43) Pub. Date: Jan. 26, 2006

(54) Toroidal continuously variable transmission with offset rollers

(76) Inventor: Todd D. Brooks, Lakeview, MN (US)

Correspondence Address: LITMAN LAW OFFICES, LTD, PO BOX 15035, CRYSTAL CITY STATION, ARLINGTON, VA, 22215, US

(21) Appl. No.: 11/239,144

(22) Filed: Sep. 30, 2005

Related U.S. Application Data
(63) Continuation-in-part of application No. 10/814,542, filed on Mar. 31, 2004.

(51) Int. Cl. F16H 15/38

(52) U.S. Cl. 476/42

(57) ABSTRACT

A toroidal continuously variable transmission with offset rollers includes a first and second toroidal disk each having inwardly facing toroidal portions that face opposite each other. A shaft having a longitudinal axis mounts the first toroidal disk on a first end and mounts the second toroidal disk on a second end. A sliding collar is mounted on the shaft between the first and the second toroidal disks and has at least two off-set rollers attached thereto. The off-set rollers are in communication with the first and the second inwardly facing toroidal portions of the toroidal disks. Translation of the sliding collar on the shaft causes the off-set rollers to rotate about a first axis, wherein the first axis is orthogonally disposed with respect to the longitudinal axis of the shaft.

### CROSS-REFERENCE TO RELATED APPLICATION

This is a continuation-in-part application that claims the benefit of U.S. Non-provisional patent application Ser. No. 10/814,542, filed Mar. 31, 2004.

### FIELD OF THE INVENTION

The present invention relates to improvements of a toroidal continuously variable transmission (toroidal CVT), and specifically to the improved angular off-set roller control for a toroidal CVT that permits the design of a very compact toroidal CVT control mechanism housed within the area between two parallel toroidal disks. More specifically, the present invention uses a translating motion along the primary axis of the rotating toroids to control the rotational tilt of the off-set rollers.

### DESCRIPTION OF THE RELATED ART

Continuously variable toroidal transmissions known in the art fall into two groups: those using essentially disk-like rollers to transmit torque from the driving disk to the driven disk and those using spherical rollers to transmit torque from the driving to the driven disk. The cylindrical face of the essentially disk shaped roller is generally curved outwardly from the axis of rotation of the cylinder producing what would be single point contact with the driving and driven disks absent surface deformation produced by the pressure of said contact.

The continuously variable toroidal transmission with offset rollers falls within the class using essentially disk shaped rollers to transfer torque from the driving disk to the driven disk. In both these classes of transmission, an essential problem involves controlling the angle formed between the roller's plane of rotation and the common axis of rotation shared by the driving and driven disks, herein referred to as the tilt angle. The known transmissions of this type include a mechanism which controls the tilt angle by rotating the roller's plane of rotation about the roller's center point. The roller's plane of rotation rotates about a pivot point placed outside the roller's plane of rotation in the continuously variable toroidal transmission with offset rollers. This change enables control of the tilt angle by varying the position of the roller support mechanism along the common axis of rotation of the driving and driven disks.

However, the control mechanisms for controlling the roller's plane of rotation are usually cumbersome due to control related mechanical linkages and usually consume much of the design space around the toroidal CVT making it large, heavy, and awkward to configure for applications needing a small lightweight toroidal CVT.

Accordingly, there is a need for a toroidal CVT of a compact, lightweight design that can be readily adapted for use in a variety of applications that prior art toroidal CVTs could not functionally address due to issues of size, weight and complexity.

### SUMMARY OF THE INVENTION

The toroidal continuously variable transmission with offset rollers of the present invention includes a first toroidal disk having an inwardly facing toroidal portion, a second toroidal disk having an inwardly facing toroidal portion, wherein each of the first and second inwardly facing toroidal portions face opposite each other. A shaft having a longitudinal axis mounts the first toroidal disk on a first end and mounts the second toroidal disk on a second end. A sliding collar is mounted on the shaft between the first and the second toroidal disks and has at least two off-set rollers attached thereto in communication with the first and the second inwardly facing toroidal portions of the toroidal disks. Translation of the sliding collar on the shaft causes the at least two off-set rollers to rotate about a first axis, wherein the first axis is orthogonally disposed with respect to the longitudinal axis of the shaft.

A further embodiment of the toroidal continuously variable transmission with offset rollers of the present invention includes a hollow shaft having a longitudinal axis with a first end for affixing a first toroidal disk to freely rotate thereupon, and a second end for affixing a second toroidal disk to freely rotate thereupon. Each first and second toroidal disks have toroidal portions facing each other. The hollow shaft further includes a either a circular or non-circular center shaft portion between the first and second ends wherein is found at least one longitudinal slot disposed parallel to the longitudinal axis of the hollow shaft.

A sliding collar having a longitudinal axis is shaped to be slidingly received on the center shaft portion of the hollow shaft. The sliding collar has at least two projections thereon for receiving at least two off-set roller assemblies. Each off-set roller assembly includes an off-set roller having a rim on the outer circumference, a roller support shaft to support rotation of the off-set roller about a longitudinal axis of the roller support shaft, and a roller support coupling affixed to an end of the roller support shaft to allow rotation of the off-set roller about a first axis orthogonal to the longitudinal axis of the roller support shaft. The roller support coupling of each off-set roller assembly is rotatably attached to the projection on the sliding collar to allow rotation of the off-set roller assembly about the first axis.

A sliding shaft having a longitudinal axis and connector receiving means is received within the hollow shaft. Finally, a connector attaches to the receiving means of the sliding shaft and projects through the longitudinal slot of the hollow shaft to affix to the sliding collar. Translation of the a sliding shaft causes the sliding collar to translate on the hollow shaft thereby causing the off-set roller assemblies to rotate about the first axis of the roller support coupling while the off-set roller assemblies contact both the first and second toroidal disks.

These and other features of the present invention will become readily apparent upon further review of the following specification and drawings.

### BRIEF DESCRIPTION OF THE DRAWINGS

FIG. 1A shows a schematic side view of a traditional toroidal continuously variable transmission with offset rollers in the configuration where the upper toroidal disk D1 is rotating at a slower speed than the lower toroidal disk D2.

FIG. 1B shows a schematic side view of a traditional toroidal continuously variable transmission with offset rollers in the configuration where the upper toroidal disk D1 is rotating at the same speed than the lower toroidal disk D2.

FIG. 1C shows a schematic side view of a traditional toroidal continuously variable transmission with offset rollers in the configuration where the upper toroidal disk D1 is rotating at a faster speed than the lower toroidal disk D2.

FIG. 2 shows a schematic side sectional view of a pair of toroidal disk and off-set rollers of the present invention.

FIG. 3 shows a perspective assembly view of the present invention.

FIG. 4 shows a perspective view of the slide shaft, hollow slotted axle and the sliding off-set roller collar in an assembled configuration.

FIG. 5 shows a perspective view of FIG. 4 additionally including the offset rollers mounted on the sliding roller-carrying collar in an assembled configuration.

FIG. 6 shows a perspective view of FIG. 5 additionally including the mating toroidal disks and the fastening hardware in an assembled configuration.

FIG. 7 shows a side view of the present invention with the slide shaft in a retracted position with respect to the hollow shaft causing the off-set rollers to pivot about a rotational connection in a direction opposite to the motion of the slide shaft.

FIG. 8 shows a side view of the present invention with the slide shaft in a neutral position with respect to the hollow shaft causing the off-set rollers maintain their positions relative to their titling rotational connection.

FIG. 9 shows a side view of the present invention with the slide shaft in an extended position with respect to the hollow shaft causing the off-set rollers to pivot about their rotational connections in a direction opposite to the motion of the slide shaft.

FIG. 10 shows a perspective cut-away view of an alternative embodiment of the present invention having a toroidal disk with a cover extending over the off-set roller section of the transmission and in contact with a roller bearing mounted on an outer annual surface of the opposing toroidal disk.

Similar reference characters denote corresponding features consistently throughout the attached drawings.

### DETAILED DESCRIPTION OF THE PREFERRED EMBODIMENTS

A toroidal CVT system replaces the belts and pulleys of a conventional CVT system with disks and power rollers. Although such a system seems drastically different, all of the components are analogous to a belt-and-pulley system and lead to the same results—a continuously variable transmission with offset rollers. (A toroid is a surface generated by a closed curve rotating about, but not intersecting or containing, an axis in its own plane.)

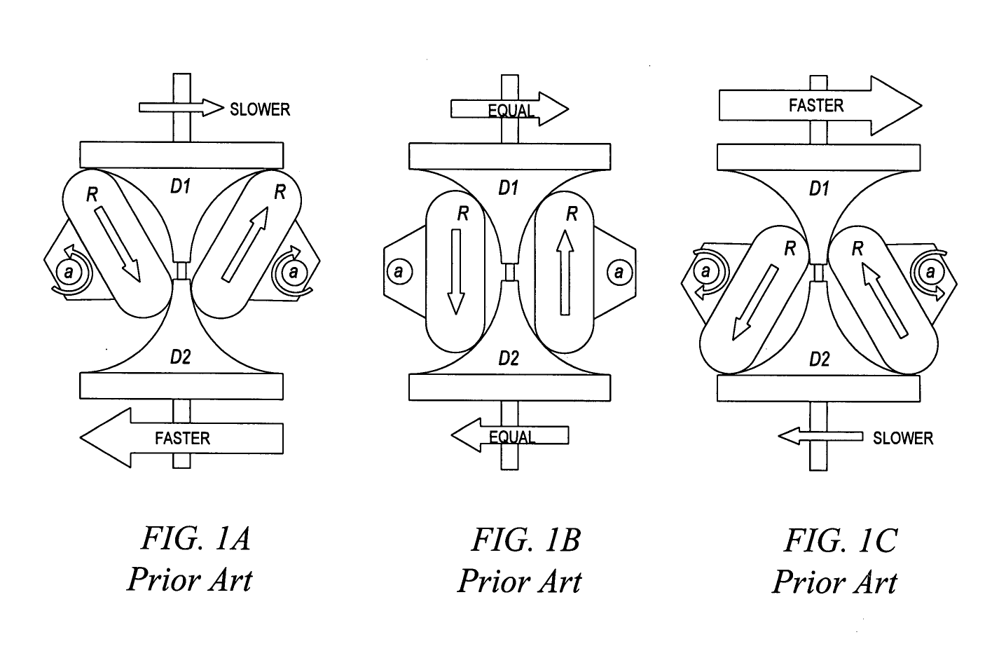

FIGS. 1A-1C demonstrate a prior art configuration of a toroidal CVT. One disc, e.g., D1, connects to the engine. This is equivalent to the driving pulley. Another disk D2 connects to the drive shaft. This is equivalent to the driven pulley. Rollers R located between the discs D1 and D2 act like the belt, transmitting power from one disk to the other.

The rollers R can rotate along two axes, a first vertical axis, shown as “a,” and a second horizontal second axis orthogonal to the vertical axis “a”. The rollers R spin around the horizontal second axis and tilt in or out around the vertical axis “a”, which allows the rollers R to contact the discs D1 and D2 in different areas. When the rollers R touch the driving disk D1 near the rim, as in FIG. 1A, they must contact the driven disk D2 near the center, resulting in an increase in speed and a decrease in torque (i.e., overdrive gear). When the rollers R are in contact with the driving disk D1 near the center, as in FIG. 1C, they must contact the driven disk D2 near the rim, resulting in a reduction in speed and an increase in torque (i.e., low gear). When the horizontal rotational axes of the rollers R are orthogonal to the rotational axes of the discs D, as in FIG. 1B, touching the discs D1 and D2 at the same location, respectively, the driving disk D1 and driven disk D2 are in a direct drive configuration—the gear ratio of D1:D2 being 1:1. A simple tilt of the rollers R incrementally changes the gear ratio, providing for smooth, nearly instantaneous ratio changes.

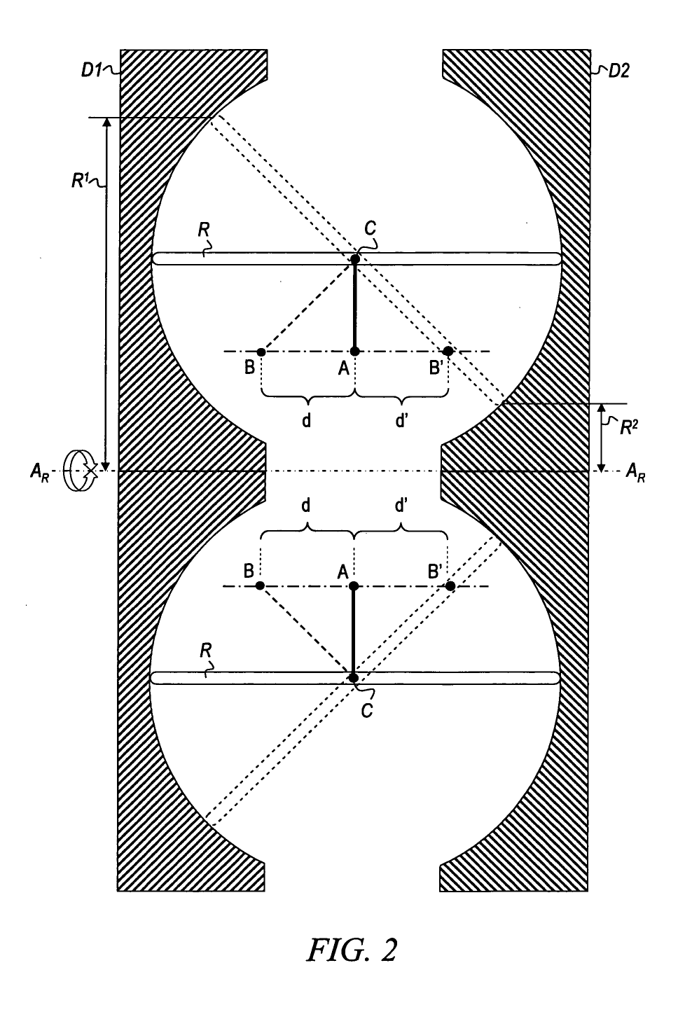

FIG. 2 is a representative schematic diagram of the present invention demonstrating the tilting of the off-set rollers R with respect to the toroidal disks D1 and D2 as the rollers R are rotated around their center point C. Toroidal disks D1 and D2 rotate about a horizontal axis of rotation AR. The rollers R have a roller center point C around which rollers R rotate.

A roller tilting link A-C is positioned between points A and roller center point C of the roller R and is illustrated by a bold line. This roller tilting link A-C is fixed at one end at roller center point C, but translates at an opposite end along a path defined by the points A-B, parallel to the rotational axis AR of disks D1 and D2. As point A of the roller tilting link A-C moves along the path A-B towards point B, the roller R tilts and creates a larger radius R¹ on disk D1, and consequently, a smaller radius R² on disk D2. The opposite will happen when point A of the roller tilting link A-C moves in an opposite direction along the path A-C′ toward point B′. Here the roller R will tilt in an opposite direction to create a smaller radius on disk D1, and consequently, a larger radius on disk D2.

The limits of travel of the roller tilting link A-C are illustrated by distances d and d′. These distances d and d′ away from a center point A cause the roller disks to stop tilting when point A of the roller tilting link A-C moves toward B or B′.

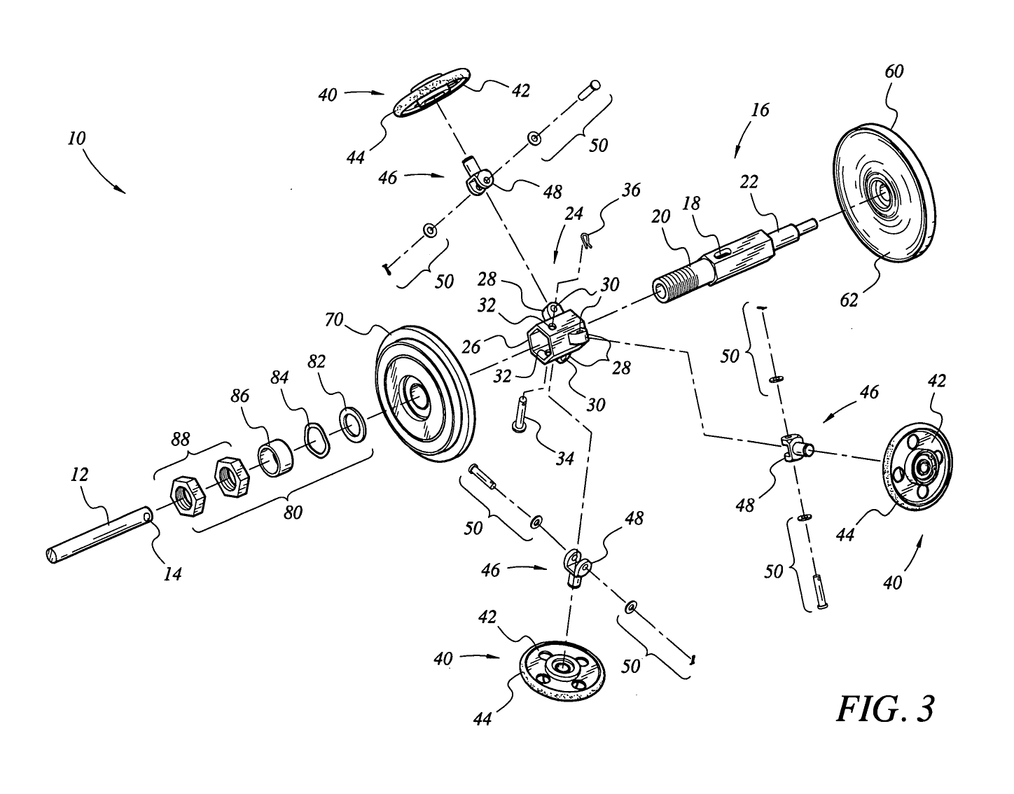

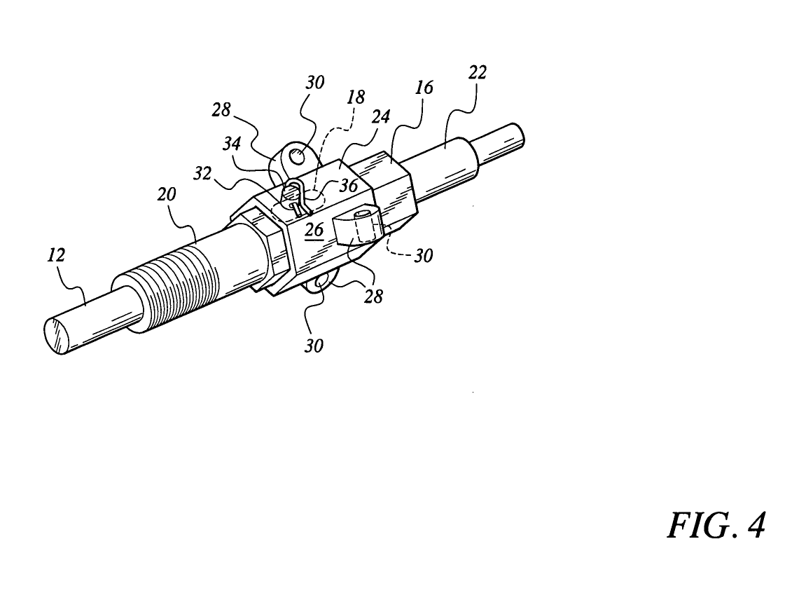

FIG. 3 represents the general preferred embodiment of the invention and correlates to FIGS. 4-6 demonstrating assembly build-up views of the present invention.

The toroidal CVT 10 of the present invention includes hollow shaft 16 having a longitudinal axis with a first end 22 for affixing a first toroidal disk 60 to freely rotate thereupon, and a second end 20 for affixing a second toroidal disk 70 to freely rotate thereupon. The first 60 and second 70 toroidal disks have toroidal portions 62 and 72 that face opposite to each other.

A center shaft portion is formed on the hollow shaft 16 between the first 22 and second 20 ends and may consist of a circular, triangular, square, hexagonal, octagonal, or any other non-circular shape.

At least one longitudinal slot 18 is disposed parallel to the longitudinal axis of the hollow shaft 16. In the preferred embodiment, two longitudinal slots project through the center shaft portion and create longitudinal openings on two opposite sides.

A sliding collar 24 having a longitudinal axis coincident with the longitudinal axis of the hollow shaft 16 is shaped to be slidingly received upon the center shaft portion. The sliding collar may consist of a circular, triangular, square, hexagonal, octagonal or any other non-circular shape to prevent independent rotation of the sliding collar 24 about the hollow shaft 16. When the center shaft portion and sliding collar 24 is circular in shape, a connecting means, e.g., pin 34, may prevent the sliding collar 24 from rotating about hollow shaft 16. Under operation of increased torque loading, a non-circular configuration is preferred to minimize stress upon any connecting member, like pin 34, wherein the torque loading is transferred between the non-circular geometry of the sliding collar 24 and the similarly shaped non-circular center shaft portion of hollow shaft 16.

The sliding collar 24 has at least two projections 28 thereon for rotatably receiving an off-set roller assembly 40. The configuration of the projections 28 on the sliding collar 24 may be in multiple configurations depending on the application and geometry of the toroidal CVT. A first configuration contemplates two projections where the sliding collar is square shaped to be received on a square shaped non-circular center shaft portion of the hollow shaft. These two projections would be disposed on opposite faces of the square shaped sliding collar.

A second configuration, for example, may have three projections 28 where the sliding collar 24 is either triangular or hexagonal shaped (as shown in FIGS. 3-6) to be received on a triangular or hexagonal shaped non-circular center shaft portion (at 18) of the hollow shaft 16. These three projections 28 would be disposed 120 degrees from each other on the triangular or hexagonal shaped sliding collar 24.

A third configuration, for example, may include four projections where the sliding collar is square or octagonal shaped to be received on a square or octagonal shaped non-circular center shaft portion of the hollow shaft. The four projections are disposed at right angles to each other on the square or octagonal shaped sliding collar.

Received upon each projection 28 of the sliding collar 24, are off-set roller assemblies 40. Each off-set roller assembly 40 includes an off-set roller 42 having a rim 44 on the outer circumference thereof. The rim material may of be metal, or a highly compression resistant resilient material to efficiently transmit rotational energy between the first toroidal disk 60 and the second toroidal disk 70. A roller support shaft 46 supports rotation of the off-set roller 42 about a longitudinal axis of the roller support shaft 46. A roller bearing (not shown) mounted on the shaft portion and connected to the off-set roller 42 allows for free rotation of the off-set roller 42. Additionally, the roller support shaft 46 allows for the off-set roller 42 to translate in an axial direction along the roller support shaft 46 as shown by the longer distance between points B-C in FIG. 2, as opposed to the shorter distance between points A-C. Though the axial translation distance is small, this feature ensures for efficient and non-binding motion of the rollers during a change in gear ratio that moves toward either limit of the roller tilting range.

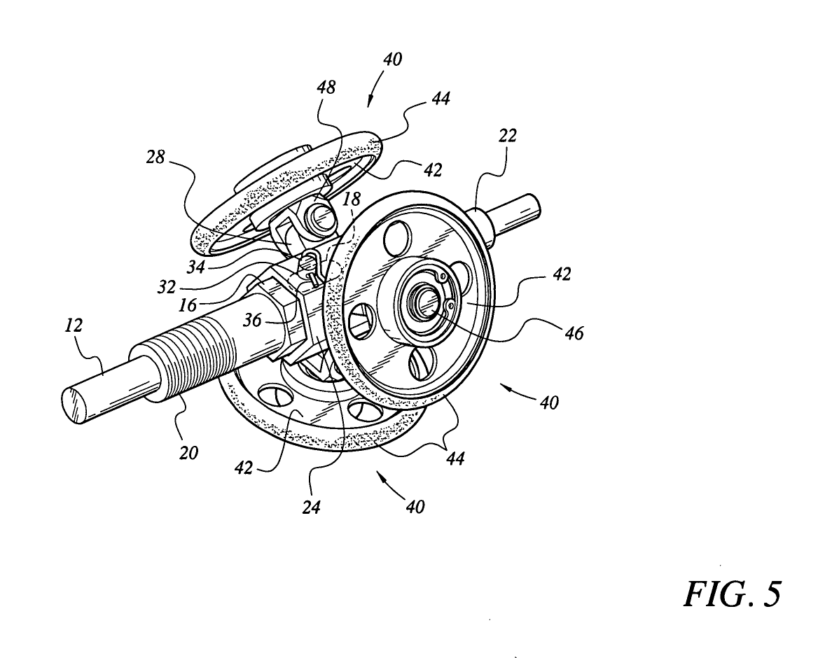

A roller support coupling 48 rotatably attaches to the projection 28 on the sliding collar 24 via hole 30 with roller fastener hardware 50 to allow rotation of the off-set roller assembly 40. See FIG. 5. Roller support coupling 48 allows rotation of the off-set roller 42 about an axis defined by projection 28 and orthogonal to the longitudinal axis of the roller support shaft 46. Additionally, the axis of the roller support coupling 48 is orthogonally disposed with respect to the longitudinal axis of the sliding collar 24 and the hollow support shaft 16.

A sliding shaft 12 having a longitudinal axis and connector receiving means comprising a hole 14 is received within the hollow shaft 24, such that the longitudinal axes of the sliding shaft 12, the sliding collar 24 and the hollow shaft 16 are coincident with one another.

A connector, in the preferred embodiment comprising a pin 34, attaches to the receiving means 14 of the sliding shaft 12, projects through the longitudinal slot 18 of the hollow shaft 16 and is received by the sliding collar 16 by means of at least one receiving hole. FIG. 3 shows a set of holes 32 projecting through the sliding collar 24 for receiving pin 34. A clip 36 may attach pin 34 in place once assembled as shown in FIG. 4.

A fastening assembly 80 for fastening at least one of the toroidal disks (e.g., 70) to the hollow shaft 16, includes a bearing washer 82 proximate the toroidal disk 70, a disk spring 82 for biasing the toroidal disk 70 toward the other oppositely disposed toroidal disk, spacing element 86, and at least one nut 88 disposed on the second end 20 of the hollow shaft 16.

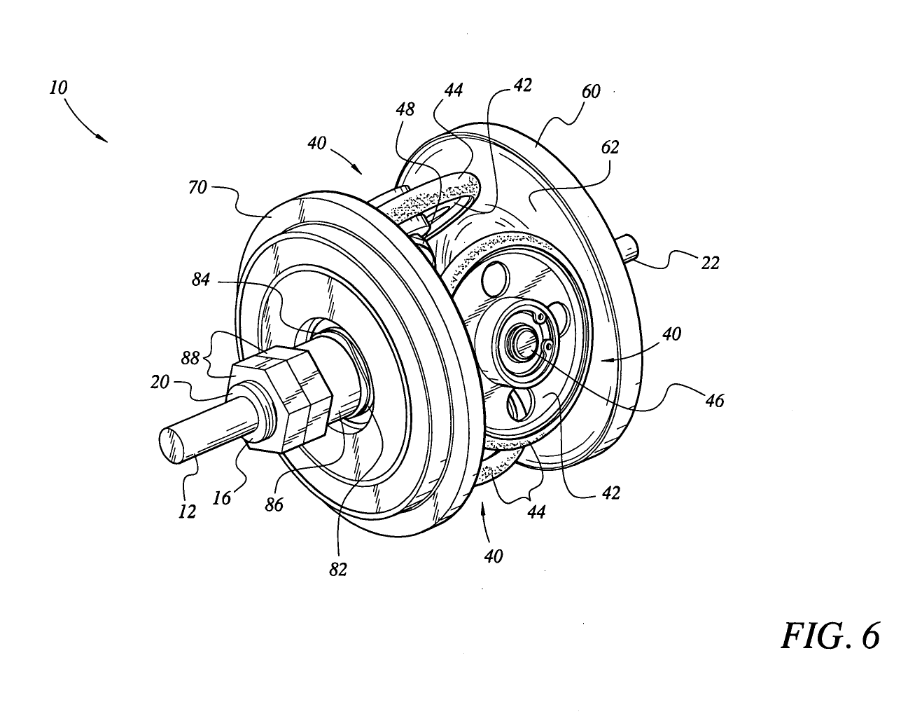

The translation motion of the a sliding shaft 12 causes the sliding collar 24 to translate on the hollow shaft 16 thereby causing the off-set roller assemblies 40 to rotate about the first axis of the roller support coupling 48 while the off-set roller assemblies 40 contact both the first 60 and second 70 toroidal disks, FIG. 6.

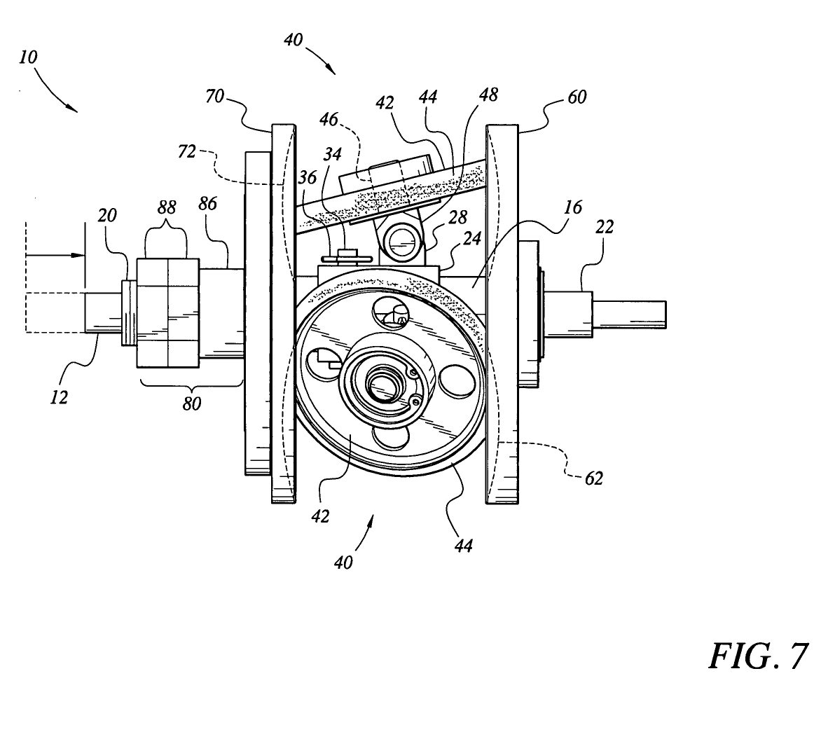

FIGS. 7-9 represent the three states of tilting the off-set rollers 40 in the present invention as a result of the linear translation of the roller collar 24.

It is important to understand the longitudinal slot 18 of the hollow shaft 16 limits the rotation of the off-set roller assemblies about the first axis of the roller support coupling 48 by limiting the translating movement of the sliding collar 24. Secondly, the longitudinal slot 18 of the hollow shaft 16 also confines the travel of the roller rims 44 within the boundaries the toroidal face portions 62 and 72 by limiting the translating movement of the sliding collar 24.

FIG. 7 shows the configuration of toroidal CVT 10 when the sliding shaft 12 is moved in an inward direction or a retracted position causing the off-set rollers 40 to rotate in a direction opposite that of the inward direction of the sliding shaft. In this configuration, the longitudinal axis of the roller support shaft 46 is at an angle other than orthogonal to the longitudinal axis of the hollow shaft 16 when the driving input configuration speed will not be equal to the output configuration speed.

Alternatively stated, when the sliding shaft 12 connected to the sliding collar 24 moves in a first direction (as indicated by the rightward arrow at 12), the rotational axes of the off-set rollers 40 around support shaft 46 move in a first direction and are no longer orthogonal to the longitudinal axis of the hollow shaft 16. The speed ratio between the driving input configuration speed through one toroidal disk and the output configuration speed of the other toroidal disk is other than 1:1, and as the sliding collar 24 continues to move in the same direction, the rate of change of the ratio is in a positive direction.

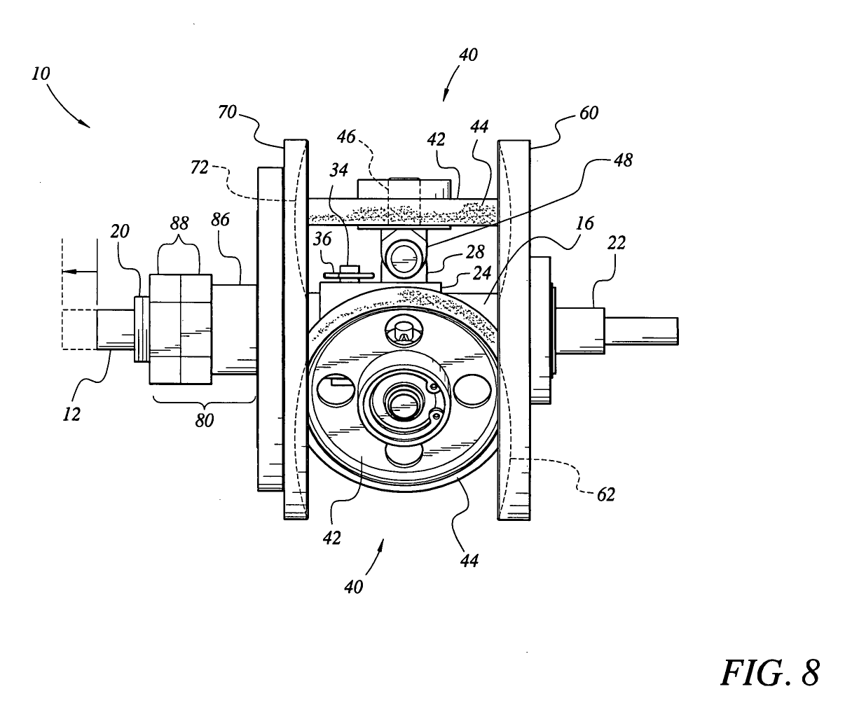

FIG. 8 shows the configuration of toroidal CVT 10 when the sliding shaft 12 is in a neutral position causing the rotational axes of the off-set rollers 40 about roller support shaft 46 to not rotate, the axis of rotation of the off-set rollers 42 being orthogonal to the longitudinal axis of the hollow shaft 16. The ratio of the driving input configuration speed through one toroidal disk is equal to the output configuration speed of the other toroidal disk.

Alternatively stated, when the longitudinal axis of the roller support shaft 46, the first axis of the roller support coupling 48, and the longitudinal axis of the hollow shaft 16 are each disposed orthogonally to each other, the driving input configuration speed through one toroidal disk is equal to the output configuration speed of the other toroidal disk.

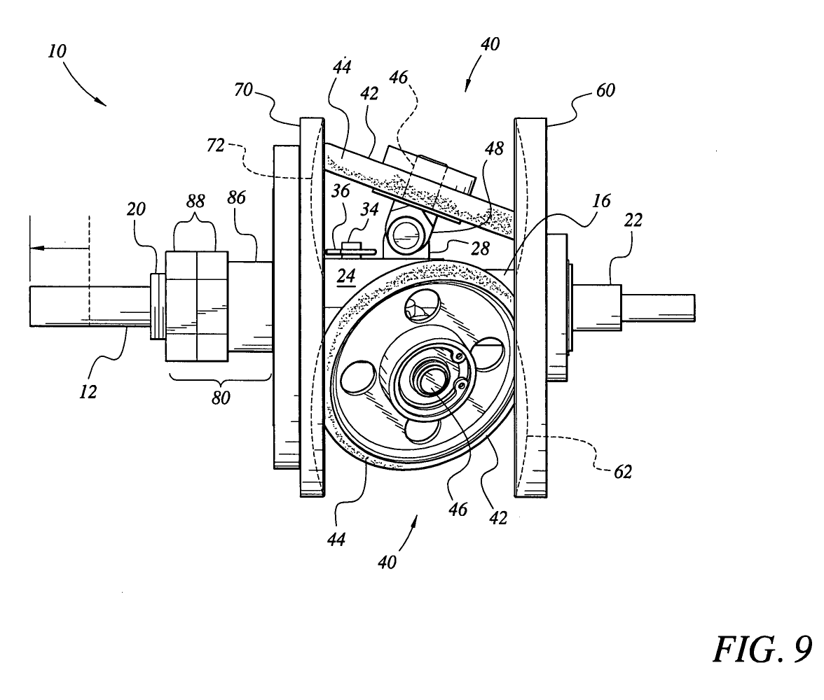

FIG. 9 shows the configuration of toroidal CVT 10 when the sliding shaft 12 is moved in an outward direction or extended position causing the off-set rollers 40 to rotate in a direction opposite that of the outward direction of the sliding shaft. In this configuration, as in FIG. 7, the longitudinal axis of the roller support shaft 46 is at an angle other than orthogonal to the longitudinal axis of the hollow shaft 16 when the driving input configuration speed will not be equal to the output configuration speed.

Alternatively stated, when the sliding shaft 12 connected to the sliding collar 24 moves in the opposite direction of FIG. 7, (as indicated by the leftward arrow at 12), the rotational axes of the off-set rollers 40 around support shaft 46 move in an opposite direction and are no longer orthogonal to the longitudinal axis of the hollow shaft 16. As before, the speed ratio between the driving input configuration speed through one toroidal disk and the output configuration speed of the other toroidal disk is other than 1:1. However, as the sliding collar 24 moves in the opposite direction, the rate of change of the ratio is in a negative direction with respect to the direction of the sliding shaft 12 of FIG. 7.

In each of the configurations of FIGS. 7-9, 1) the first toroidal disk 60, 2) the second toroidal disk 70, and 3) the assembly of the roller collar 24 slidingly attached to hollow shaft 16, each are able to rotate independently of each other. Each may be configured in one of a fixed position, a driving input configuration, or an output configuration with respect to each other. Altogether there are six configurations as described hereinafter.

For example, when the hollow shaft 16 is in a fixed position, and the first toroidal disk 60 is in a driven configuration, the second toroidal disk 70 is in an output configuration. And when the second toroidal disk 70 is in a driven configuration, the first toroidal disk 60 is in an output configuration.

Another example is when the first toroidal disk 60 is in a fixed position, and the second toroidal disk 70 is in a driven configuration, the hollow shaft 16 is in an output configuration. And when the hollow shaft 16 is in a driven configuration, the second toroidal disk 70 is in an output configuration.

A final example is when the second toroidal disk 70 is in a fixed position, and the first toroidal disk 60 is in a driven configuration, the hollow shaft 16 is in an output configuration. And when the hollow shaft 16 is in a driven configuration, the first toroidal disk 60 is in an output configuration.

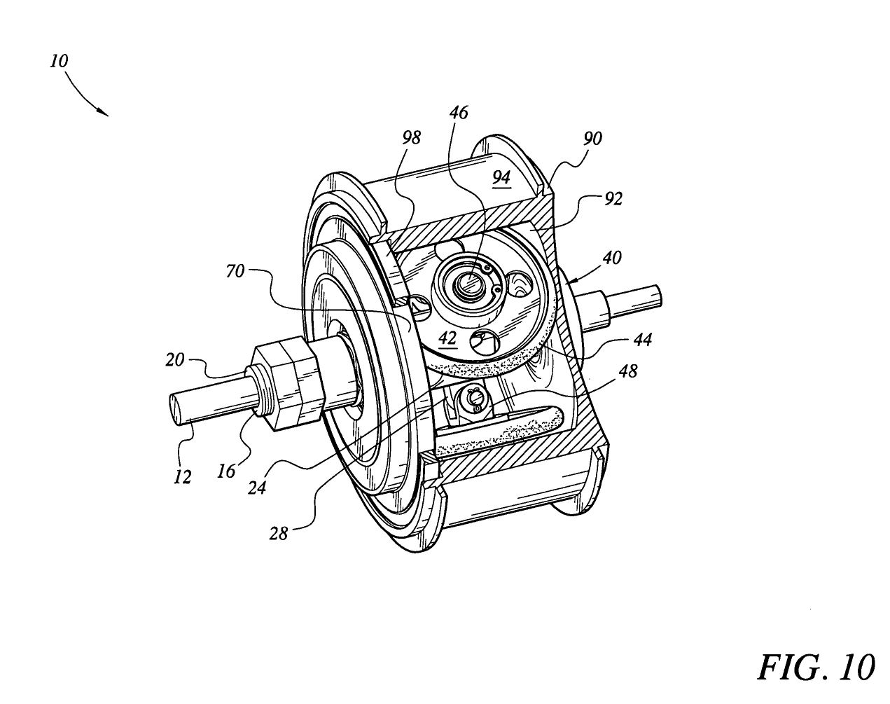

FIG. 10 demonstrates an alternative embodiment of the invention showing an enclosure over the area between the two toroidal disks containing the tilt adjustment mechanism and the off-set rollers. An alternatively designed toroidal disk 90 may replace either the first 60 or second 70 toroidal disk of FIGS. 3-9. However, this toroidal disk 90 includes an integral axially projecting cover portion 94 extending between the outer circumferential edges of the toroidal disks 70 and 90. A roller bearing 98 is mounted on the circumferential outer edge of the other toroidal disk 70 for receiving the cover portion to rotate freely thereon and totally enclose the roller assemblies 40 therein. The advantages to this design prevent dirt and foreign particles from entering into the toroidal chamber and allow for the integral cover portion 94 and toroidal disk 90 to be used to receive a belt-drive or be connected to spokes of a wheel, e.g., a motorcycle or bicycle wheel. In this latter configuration, the hollow shaft 16 would act as a fixed axle attached to the fork of a bike, toroidal disk 70 would be configured to be driven from a chain drive, and cover portion 94 and toroidal disk 90 would connect to and drive the spokes of the bike wheel.

It is to be understood that the present invention is not limited to the embodiments described above, but encompasses any and all embodiments within the scope of the following claims.

I claim:

1. A toroidal continuously variable transmission with offset rollers, comprising:
a) hollow shaft having a longitudinal axis, said hollow shaft including:
1) a first end for affixing a first toroidal disk to freely rotate thereupon;
2) second end for affixing a second toroidal disk to freely rotate thereupon, said first and second toroidal disks having toroidal portions facing each other;
3) a center shaft portion between said first and second ends; and
4) at least one longitudinal slot disposed parallel to the longitudinal axis of said hollow shaft;
b) a sliding collar having a longitudinal axis, said sliding collar is shaped to be slidingly received on said center shaft portion, said sliding collar having at least two projections thereon;
c) at least two off-set roller assemblies, wherein each off-set roller assembly comprises:
1) an off-set roller having a rim on the outer circumference of said roller;
2) a roller support shaft to support rotation of said off-set roller about a longitudinal axis of said roller support shaft; and
3) a roller support coupling affixed to an end of said roller support shaft to allow rotation of said off-set roller about a first axis orthogonal to the longitudinal axis of said roller support shaft;
wherein said roller support coupling of each off-set roller assembly is rotatably attached to said projection on said sliding collar to allow rotation of said off-set roller assembly about said first axis;
d) a sliding shaft having a longitudinal axis, and connector receiving means, wherein said sliding shaft is received within said hollow shaft; and
e) a connector, wherein said connector attaches to said receiving means of said sliding shaft, projects through said longitudinal slot of said hollow shaft and affixes to said sliding collar;
whereby translation of said a sliding shaft causes said sliding collar to translate on said hollow shaft thereby causing said off-set roller assemblies to rotate about said first axis of said roller support coupling while said off-set roller assemblies contact both said first and second toroidal disks.

2. The toroidal continuously variable transmission with offset rollers of claim 1, wherein said center shaft portion between said first and second ends is circular.

3. The toroidal continuously variable transmission with offset rollers of claim 1, wherein said center shaft portion between said first and second ends is non-circular.

4. The toroidal continuously variable transmission with offset rollers of claim 3, wherein said non-circular center shaft portion of said hollow shaft is a shape selected from the group consisting of:
a triangular shape
a square shape
a hexagonal shape, and
an octagonal shape.

5. The toroidal continuously variable transmission with offset rollers of claim 3, wherein said non-circular center shaft portion prevents independent rotation of said sliding collar thereon.

6. The toroidal continuously variable transmission with offset rollers of claim 3, wherein said sliding collar is a shape selected from the group consisting of:
a triangular shape
a square shape
a hexagonal shape, and
an octagonal shape.

7. The toroidal continuously variable transmission with offset rollers of claim 3, wherein the shape of said sliding collar prevents independent rotation about said hollow shaft.

8. The toroidal continuously variable transmission with offset rollers of claim 3, wherein said at least two projections are two projections and said sliding collar is square shaped to be received on a square shaped non-circular center shaft portion of said hollow shaft, and said two projections are disposed on opposite faces of said square shaped sliding collar.

9. The toroidal continuously variable transmission with offset rollers of claim 3, wherein said at least two projections are three projections and said sliding collar is triangular or hexagonal shaped to be received on a triangular or hexagonal shaped non-circular center shaft portion of said hollow shaft, and said three projections are disposed at 120 degrees from each other on said triangular or hexagonal shaped sliding collar.

10. The toroidal continuously variable transmission with offset rollers of claim 3, wherein said at least two projections are four projections and said sliding collar is square or octagonal shaped to be received on a square or octagonal shaped non-circular center shaft portion of said hollow shaft, and said four projections are disposed at right angles on said square or octagonal shaped sliding collar.

11. The toroidal continuously variable transmission with offset rollers of claim 1, wherein said at least one longitudinal slot comprises two longitudinal slots that project through said center shaft portion on two sides.

12. The toroidal continuously variable transmission with offset rollers of claim 1, wherein said longitudinal axis of said sliding collar is coincident with said longitudinal axis of said hollow shaft.

13. The toroidal continuously variable transmission with offset rollers of claim 1, wherein said roller support shaft allows for said off-set roller to translate in an axial direction along said roller support shaft.

14. The toroidal continuously variable transmission with offset rollers of claim 1, wherein said first axis of said roller support coupling is orthogonally disposed with respect to the longitudinal axis of said sliding collar and said hollow support shaft.

15. The toroidal continuously variable transmission with offset rollers of claim 1, wherein said longitudinal axis of said roller support shaft is orthogonally disposed to said first axis of said roller support coupling.

16. The toroidal continuously variable transmission with offset rollers of claim 1, wherein said first axis of said roller support coupling is orthogonally disposed to said longitudinal axis of said hollow shaft.

17. The toroidal continuously variable transmission with offset rollers of claim 1, wherein said longitudinal axes of said sliding shaft, said sliding collar and said hollow shaft are coincident with each other.

18. The toroidal continuously variable transmission with offset rollers of claim 1, wherein said connector comprises a pin.

19. The toroidal continuously variable transmission with offset rollers of claim 1, wherein said sliding collar further comprises connector receiving means.

20. The toroidal continuously variable transmission with offset rollers of claim 19, wherein said sliding collar connector receiving means comprises a set of through holes projecting through said sliding collar orthogonal to the longitudinal axis of said sliding collar.

21. The toroidal continuously variable transmission with offset rollers of claim 19, wherein said connector:
1) is affixed through a first hole of said set of through holes projecting through said sliding collar;
2) projects through a first longitudinal slot on said hollow shaft;
3) projects through said connector receiving means of said sliding shaft;
4) projects through a second longitudinal slot on said hollow shaft; and
5) is affixed through a second hole of said set of through holes projecting through said sliding collar;
whereby translating said a sliding shaft causes said sliding collar to translate on said hollow shaft thereby causing said off-set roller assemblies to rotate about said first axis of said roller support coupling while contacting both said first and second toroidal disks.

22. The toroidal continuously variable transmission with offset rollers of claim 1, further comprising a fastening assembly for fastening at least one of said toroidal disks to said hollow shaft, said fastening assembly further including a disk spring for biasing said at least one of said toroidal disks toward the other oppositely disposed toroidal disk.

23. The toroidal continuously variable transmission with offset rollers of claim 1, wherein said longitudinal slot of said hollow shaft limits the rotation of said off-set roller assemblies about said first axis of said roller support coupling.

24. The toroidal continuously variable transmission with offset rollers of claim 1, wherein said longitudinal slot of said hollow shaft confines the travel of said roller rims within the boundaries said toroidal face portions.

25. The toroidal continuously variable transmission with offset rollers of claim 1, wherein said first toroidal disk, said second toroidal disk, and said hollow shaft each 1) rotate independently of each other, and 2) may be in one of a fixed position, a driving input configuration, or an output configuration with respect to each other;
wherein when the rotational axes of said at least two off-set rollers are orthogonal to said longitudinal axis of said hollow shaft, ratio of said driving input configuration speed is equal to said output configuration speed.

26. The toroidal continuously variable transmission with offset rollers of claim 1, wherein said first toroidal disk, said second toroidal disk, and said hollow shaft each 1) rotate independently of each other, and 2) may be in one of a fixed position, a driving input configuration, or an output configuration with respect to each other;
wherein when said sliding shaft connected to said sliding collar moves in a first direction such that the rotational axes of said at least two off-set rollers move in a first direction and are not orthogonal to said longitudinal axis of said hollow shaft, the speed ratio between said driving input configuration speed and said output configuration speed is other than 1:1, and as said sliding collar moves in said first direction, the 2 rate of change of the ratio is in a positive direction.

27. The toroidal continuously variable transmission with offset rollers of claim 26, wherein when said sliding shaft connected to said sliding collar moves in a second direction opposite to that of said first direction such that the rotational axis of said at least two off-set rollers move in a second direction opposite that of said first direction and are not orthogonal to said longitudinal axis of said hollow shaft, the speed ratio between said driving input configuration speed and said output configuration speed is other than 1:1, and as said sliding collar moves in said second direction, the rate of change of the ratio is in a negative direction.

28. The toroidal continuously variable transmission with offset rollers of claim 1, wherein said first toroidal disk, said second toroidal disk, and said hollow shaft each 1) rotate independently of each other, and 2) may be in one of a fixed position, a driving input configuration, or an output configuration with respect to each other;
wherein said longitudinal axis of said roller support shaft, said first axis of said roller support coupling, and said longitudinal axis of said hollow shaft are each disposed orthogonally to each other when said driving input configuration speed is equal to said output configuration speed.

29. The toroidal continuously variable transmission with offset rollers of claim 1, wherein said first toroidal disk, said second toroidal disk, and said hollow shaft each 1) rotate independently of each other, and 2) may be in one of a fixed position, a driving input configuration, or an output configuration with respect to each other;
wherein said longitudinal axis of said roller support shaft is at an angle other than orthogonal to said longitudinal axis of said hollow shaft when said driving input configuration speed is not equal to said output configuration speed.

30. The toroidal continuously variable transmission with offset rollers of claim 1, wherein said first toroidal disk, said second toroidal disk, and said hollow shaft each rotate independently of each other, and when said hollow shaft is in a fixed position:
a) and said first toroidal disk is in a driven configuration, said second toroidal disk is in an output configuration; and
b) and said second toroidal disk is in a driven configuration, said the first toroidal disk is in an output configuration.

31. The toroidal continuously variable transmission with offset rollers of claim 1, wherein said first toroidal disk, said second toroidal disk, and said hollow shaft each rotate independently of each other, and when said first toroidal disk is in a fixed position:
a) and said second toroidal disk is in a driven configuration, said hollow shaft is in an output configuration; and
b) and said hollow shaft is in a driven configuration, said second toroidal disk is in an output configuration.

32. The toroidal continuously variable transmission with offset rollers of claim 1, wherein said first toroidal disk, said second toroidal disk, and said hollow shaft each rotate independently of each other, and when said second toroidal disk is in a fixed position:
a) and said first toroidal disk is in a driven configuration said hollow shaft is in an output configuration; and
b) and said hollow shaft is in a driven configuration said first toroidal disk is in an output configuration.

33. The toroidal continuously variable transmission with offset rollers of claim 1, further comprising:
wherein one of said first and second toroidal disks further comprises an integral axially projecting cover portion extending between the outer circumferential edges of said first and second toroidal disks; and,
a roller bearing mounted on the circumferential outer edge of the other one of said first and second toroidal disks for receiving said cover portion to rotate freely thereon.

34. A toroidal continuously variable transmission with offset rollers, comprising:
a first toroidal disk having an inwardly facing toroidal portion;
a second toroidal disk having an inwardly facing toroidal portion, wherein each of said first and second inwardly facing toroidal portions face opposite each other;
a shaft having a longitudinal axis for mounting said first toroidal disk on a first end and for mounting said second toroidal disk on a second end; and
a sliding collar mounted on said shaft between said first and said second toroidal disks having at least two off-set rollers attached thereto, said at least two off-set rollers are in communication with said first and said second inwardly facing toroidal portions of said toroidal disks;
whereby translation of said sliding collar on said shaft causes said at least two off-set rollers to rotate about a first axis, wherein said first axis is orthogonally disposed with respect to said longitudinal axis of said shaft.
